(19) United States
(12) Patent Application Publication
(10) Pub. No.: US 2026/0109430 A1
(43) Pub. Date: Apr. 23, 2026

(54) Method for Controlling a Shifting Process

(71) Applicant: ZF Friedrichshafen AG, Friedrichshafen (DE)

(72) Inventors: Uwe Schraff, Markdorf (DE); Michel Wiemer, Weingarten (DE); Thomas Hodrius, Weiler- Simmerberg (DE); Uwe Griesmeier, Markdorf (DE); Günter Riess, Eriskirch / Mariabrunn (DE)

(21) Appl. No.: 19/116,937

(22) PCT Filed: Sep. 29, 2022
(86) PCT No.: PCT/EP2022/077174

§ 371 Date: Mar. 28, 2025

(51) Int. Cl. B62M 9/123; B62M 9/122; B62M 9/132; B62M 9/133

(52) U.S. Cl. CPC B62M 9/123; B62M 9/122; B62M 9/132; B62M 9/133

(57) ABSTRACT

A method for open-loop control of a gear change operation of an electric gear shifting mechanism of a bicycle. The method includes receiving a shift request signal. The method further includes determining a pedal crank position of a pedal crank of the bicycle. Additionally, the method includes actuating the electric gear shifting mechanism according to the pedal crank position.

### CROSS-REFERENCE TO RELATED APPLICATION

The present application is a nationalization of PCT/EP2022/077174 filed in the European Patent Office on Sep. 29, 2022, the entirety of which is incorporated by reference for all purposes.

### FIELD OF THE INVENTION

The present invention relates generally to a method for the open-loop control of a gear change operation or “shifting process”, wherein the load on the shift components is reduced. The present invention further relates generally to an associated bicycle having an associated control device.

### BACKGROUND

Bicycles and electric bicycles having derailleurs, hub gears, and bottom bracket gear shift devices are known from the prior art. These can be actuated, i.e., the gear change operation can be triggered, both manually and electrically, for example, by radio or cable.

In known gear shifting mechanisms from the prior art, the problem arises that shifting under load results in an increased load on the components of the gear shifting mechanism, and noise that is unpleasant for the user can occur. Shifting under load is understood to mean a gear shift carried out while the bicycle rider applies an increased force to the pedals and, thus, to the bottom bracket and the gear shifting mechanism connected thereto or integrated therein.

This problem occurs both with manual gear shifting mechanisms and with electrically actuated gear shifting mechanisms. The electrically actuated gear shifting mechanisms can be triggered either on the basis of a user request, which is received from an input device on the bicycle, and on the basis of an automatic system, which controls the gear change in an open loop.

An automatic system can be configured, for example, such that a predetermined cadence is maintained and corresponding gear change operations are triggered when there is a deviation from this cadence.

### SUMMARY OF THE INVENTION

One problem addressed by the present invention is therefore that of providing an open-loop control method for the open-loop control of a gear change operation of a bicycle, which open-loop control method loads the components to a reduced extent.

A corresponding method for the open-loop control of a gear change operation of an electric gear shifting mechanism of a bicycle according to the present invention is to be described in the following.

An electric gear shifting mechanism is to be understood as a gear shifting mechanism in which the actuation and thus the triggering of the gear shifting mechanism are at least partially electrically carried out. Correspondingly, the actuation is implemented by electrical pulses. By such electrical pulses, for example, a rear derailleur or a front derailleur is actuated. The actuation can be carried out automatically on the basis of an automatic shifting system or on the basis of a user request by an input device, for example, a lever. The bicycle can be a bicycle which is propelled solely by muscle power as well as a bicycle which is at least partially electrically propelled, for example, a pedelec or an e-bike. The latter has a motor, or an electric machine, which is supplied with power by a battery.

This battery can also be used to supply the electric gear shifting mechanism. A battery is also understood to be a rechargeable battery.

In the first step of the aforementioned method, initially a shift request signal is received. This shift request signal can be received, for example, from a user who expresses their shift request by a user input at a user input device, for example, a shift lever. The shift request signal can also be received from an automatic shifting system, which automatically controls the gear shift in an open loop, for example, on the basis of the cadence. Receiving is understood to mean receiving an electrical signal but also reading out a corresponding indicator from a memory.

Next, the pedal crank position of the pedal crank of the bicycle is determined. This determination can be carried out on the basis of receipt of a signal from a corresponding sensor, for example, a pedal crank sensor. The pedal crank position can also be determined by another sensor, such as a sensor installed in the bottom bracket, and by deriving a crank position from this sensor value.

Next, in the third step of the method, the gear shift is actuated according to the determined pedal crank position. This can be carried out by outputting a control signal to the electric gear shifting mechanism of the bicycle. Correspondingly, the actuation is carried out on the basis of the received shift request and the pedal crank position such that the gear shift is triggered, or actuated, with a certain delay, in contrast to a direct actuation when a shift request signal is received.

By taking the pedal crank position into account, it is therefore possible to move the gear change operation to a point in time which is optimal for the correspondingly used gear shifting mechanism. Correspondingly, for example, the load on the components of the gear shifting mechanism can be reduced or even the noise development can be reduced.

Here, for example, an actuation can be carried out such that the gear change operation is carried out at a point in time at which the application of force onto the pedals by the rider is minimal, i.e., when the pedals are located in a vertical position and thus in a dead center.

According to one embodiment, the actuation can be carried out according to a difference between the determined crank position and a pedal crank position having minimal pedal torque. On the one hand, the objective can be to achieve a difference of zero, i.e., the pedal crank position is already located at dead center, i.e., at the point of a minimal pedal torque, and, on the other hand, an actuation can be carried out with offset, i.e., the difference is, for example, predefined but not equal to zero. This is, for example, advantageous when a shift time, i.e., a time between an actuation and an execution of the gear change operation or an execution of a certain portion of the gear change operation, is known, and therefore the gear change operation or a certain portion of the gear change operation is to be moved to the points in time of the minimal pedal torque in order to further reduce the load on the gear shifting mechanism.

As described above, in one embodiment, the shift request signal can be determined either on the basis of a control signal for the automatic gear change or on the basis of a shift request of a user, which has been received from an input device. The control signal for the automatic gear change is output, for example, from an automatic shifting system, and determined, for example, according to a cadence, which is predefined or is established by the user. A corresponding input device can also be used to input a shift request of a user, which input device can be, for example, a shift lever located in the front part of the bicycle.

In another embodiment, the step of actuating the gear shifting mechanism can also be determined on the basis of the pedal cadence, a pedal acceleration, and/or a predetermined shift time of the gear shifting mechanism.

As described above in this context, by taking the pedal acceleration, the pedal cadence, and/or a known shift time into account, it is possible to determine the point in time at which, i.e., the pedal crank position at which, a gear shifting mechanism is to be triggered, so that the gear change operation or even a certain portion of the gear change operation is triggered at the point in time of a minimal application of force onto the pedals. If it is known, for example, that one revolution lasts for 300 milliseconds at the current pedal cadence, and it is also known that, after the gear shifting mechanism has been actuated, the portion of the gear change operation which is to be located at dead center lasts for 250 milliseconds, then this information can be used to determine the point in time at which, and thus the pedal crank position at which, an actuation must be carried out.

Consequently, it is advantageous to also allow the pedal cadence, a pedal acceleration, and/or a known shift time of the gear shifting mechanism to be incorporated in the determination.

In one embodiment, it can be desirable to apply such an above-described delay of the actuation only when the current pedal cadence, i.e., the rotational speed of the pedal device, is in a certain range, since a direct triggering can be preferred when the cadence is very low, so that a delay between the shift request and the triggering/actuation is not noticed, and a direct triggering is also to be preferred when the cadence is very high, since it can be more difficult to achieve the desired reproducibility. Correspondingly, it can be provided that the actuation is carried out according to the determined pedal crank position only when the pedal cadence is above a first threshold value and/or below a second threshold value, which second threshold value is greater than the first threshold value, and otherwise a direct actuation, i.e., an actuation without delay, is carried out.

Similarly, it can be provided in one preferred embodiment that an actuation is carried out according to the determined pedal crank position only when a predefined riding mode is selected, and otherwise a direct actuation, i.e., an actuation without delay, is carried out. Correspondingly, for example, a riding mode can be provided, in which a shift is always carried out directly, and another riding mode can be provided, in which a delay is acceptable.

In another embodiment, the method also includes the steps of determining an actuation point on the basis of the pedal cadence and/or the pedal acceleration as well as the shift time. Next, the step of actuating is carried out at the determined actuation point.

With respect to the advantages of incorporating the pedal cadence, the pedal acceleration, and the shift time, reference is made to the aforementioned comments.

An actuation point can be either a point in time or, for example, a certain pedal crank position.

According to another embodiment, by the actuation, a predetermined gear change phase of the gear shifting mechanism can take place at the point in time of the minimal pedal torque, i.e., when the pedal crank is in a vertical position. If the gear change operation has, for example, multiple phases, wherein one of the gear change phases should be advantageously moved to dead center due to the load on the gear shifting mechanism, precisely that gear change phase can be correspondingly moved and positioned in order to further reduce the load on the gear shifting mechanism. Such a gear change phase can be, for example, the point in time at which a pawl of a gear shifting mechanism engages, which can induce a strong load on the gear shifting mechanism and a strong acoustic load.

In one embodiment, the aforementioned pedal crank position having minimal pedal torque can be a vertical position of the pedal crank. In other words, this is the aforementioned dead center or even a pedal position in which the force applied by the user of the bicycle is minimal.

The aforementioned method steps are to be understood not to be limited to the presented order; instead, the method steps can also be carried out in another order if this is technically possible.

The present invention also relates to a bicycle having an electric gear shifting mechanism, wherein the bicycle also has a control device, which carries out a method according to one of the preceding embodiments.

As described above, the bicycle can be a bicycle which is operated solely by muscle power, but also an electric bicycle which has a motor and a battery for assisting the propulsion of the bicycle. With respect to the definition of the electric gear shifting mechanism, reference is made to the comments presented above.

A control device can be, for example, a microprocessor, which is provided externally or in one of the other components described here. The control device can also be a software component in software, which is already present and is run on an existing microprocessor on a computation unit. According to the invention, the functionalities of the control device can also be distributed onto multiple microprocessors.

### BRIEF DESCRIPTION OF THE FIGURES

FIG. 1 shows a method according to the invention.

FIG. 2 shows a schematic view of a bicycle according to the present invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

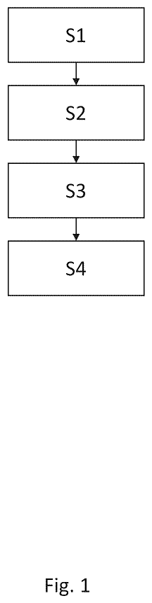

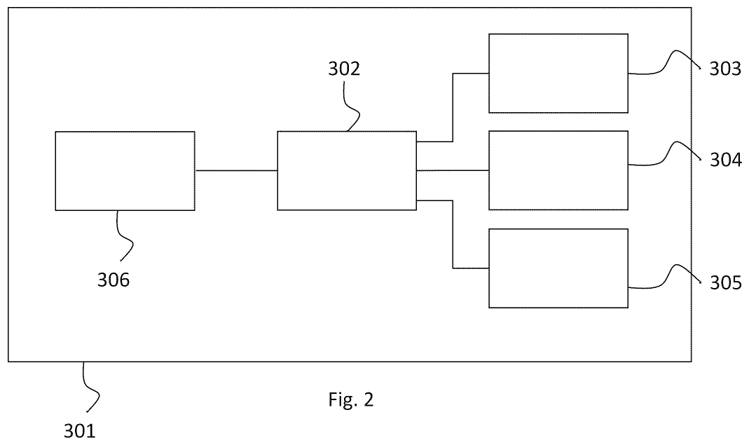

Initially, an exemplified method of the present invention is to be described with reference to FIG. 1. Reference is also already made to the schematic view of the device shown in FIG. 2.

Initially, in step S1 in FIG. 1, a shift request signal, which represents a shift request of the user or of the automatic gear shifting mechanism, or automatic shifting system, is received at the control device 302 in FIG. 2. The shift request signal can be received from the input device 303 of the bicycle 301, which is shown in FIG. 2, when the input device is actuated by a user. Using an electrical signal, this shift request is then transmitted to the control device 302, where it is received. Alternatively, such a shift request can be transmitted from the automatic shifting system 304 in FIG. 2 and received at the control device 302 in FIG. 2.

Then, on the basis of the sensor data received from the sensor device 305 in FIG. 2, the pedal crank position of the bicycle is determined by the control device 302, step S2 in FIG. 1.

Next, in the present exemplary embodiment, in step S3, a determination of an actuation point is carried out on the basis of the pedal cadence, the pedal acceleration, and the shift time. The pedal cadence and the pedal acceleration are also determined by the control device 302 using the data received from the sensor unit 305. In the present embodiment, the actuation point is selected such that a certain portion of the gear change operation is carried out at the point in time of the vertical orientation of the pedal cranks. For this purpose, a predetermined shift time between the triggering, or actuation, and the execution of the particular portion of the gear change operation, which shift time is known for the electric gear shifting mechanism, is taken into account.

Next, in step S4 in FIG. 1, the gear shifting mechanism is actuated at this thusly determined actuation point by activating the electric gear shifting mechanism 306 of the bicycle 301 in FIG. 2 using an electrical signal.

The electric gear shifting mechanism then carries out the corresponding gear change operation, wherein, due to the selected actuation point, the predetermined gear change phase of the gear shifting mechanism is carried out at the point in time of the minimal pedal torque and thus the load on the bicycle components is reduced.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

Step S1 receiving the shift request
Step S2 determining the pedal crank position
Step S3 determining the actuation point
Step S4 actuating the gear shifting mechanism
301 bicycle
302 control device
303 input device
304 automatic shifting system
305 sensor device
306 electric gear shift mechanism

1-9. (canceled)

10. A method for open-loop control of a gear change operation of an electric gear shifting mechanism (306) of a bicycle (301), the method comprising:
receiving (S1) a shift request signal;
determining (S2) a pedal crank position of a pedal crank of the bicycle (301); and
actuating (S4) the electric gear shifting mechanism (306) according to the pedal crank position.

11. The method of claim 10, wherein actuating (S4) the electric gear shifting mechanism (306) comprises actuating (S4) the electric gear shifting mechanism (306) according to a difference between the pedal crank position and a reference pedal crank position, the reference pedal crank position having minimal pedal torque.

12. The method of claim 10, wherein receiving (S1) the shift request signal comprises receiving (S1) the shift request signal based on either an automatic control signal for an automatic gear change or a user shift request by a user received via an input device (303).

13. The method of claim 10, wherein actuating (S4) the electric gear shifting mechanism (306) comprises actuating (S4) the electric gear shifting mechanism (306) further based on one or more of a pedal cadence, a pedal acceleration, or a known shift time of the electric gear shifting mechanism.

14. The method of claim 10, wherein actuating (S4) the electric gear shifting mechanism (306) comprises actuating (S4) the electric gear shifting mechanism (306) based on the pedal crank position when a pedal cadence is above a first threshold value and below a second threshold value, the second threshold value being greater than the first threshold value, and actuating (S4) the electric gear shifting mechanism (306) to perform a direct actuation of the electric gear shifting mechanism (306) when the pedal cadence is below the first threshold value or above the second threshold value.

15. The method of claim 10, further comprising:
determining an actuation point (S3) based at least one of a pedal cadence, pedal acceleration, or a known shift time of the electric gear shifting mechanism,
wherein actuating (S4) the electric gear shifting mechanism (306) comprises actuating (S4) the electric gear shifting mechanism (306) at the actuation point.

16. The method of claim 15, wherein the actuation point is an actuation pedal crank position,
wherein actuating (S4) the electric gear shifting mechanism (306) at the actuation point carries out a predetermined gear change phase of the electric gear shifting mechanism at a point in time associated with minimal pedal torque.

17. The method of claim 16, wherein the minimal pedal torque is associated with a vertical position of the pedal crank.

18. A bicycle (301), comprising:
an electric gear shifting mechanism (306),
a control device (302) configured to perform the method of claim 10.
